(19) United States
(12) Patent Application Publication
(10) Pub. No.: US 2021/0001750 A1
(43) Pub. Date: Jan. 7, 2021

(54) CHARGING PILE

(71) Applicant: TSINGHUA UNIVERSITY, Beijing (CN)

(72) Inventors: Languang LU, Beijing (CN); Yalun LI, Beijing (CN); Minggao OUYANG, Beijing (CN); Jiuyu DU, Beijing (CN); Jianqiu LI, Beijing (CN); Xuning FENG, Beijing (CN); Xuebing HAN, Beijing (CN)

(21) Appl. No.: 16/633,680

(22) PCT Filed: Nov. 6, 2018
(86) PCT No.: PCT/CN2018/114032

§ 371 Date: Jan. 24, 2020

(30) Foreign Application Priority Data
Dec. 1, 2017 (CN) 201711250687.4

(51) Int. Cl. B60L 58/24; H02J 7/00; H01M 10/613; H01M 10/625; H01M 10/6552; H01M 10/6568; H01M 10/6563; H01M 10/667; H01M 10/42; H01M 10/46

(52) U.S. Cl. CPC B60L 58/24; H02J 7/007194; H02J 7/0045; H01M 10/613; H01M 10/625; H01M 10/6552; H01M 2010/4278; H01M 10/6563; H01M 10/667; H01M 10/425; H01M 10/46; H02J 2310/48; H01M 2220/20; H01M 10/6568

(57) ABSTRACT

A charging pile includes a heat exchange tube, a coolant output tube and a coolant input tube that are connected to the heat exchange tube. The charging pile allows the on-board battery to be charged in an optimal temperature range, thus reducing the time for charging the on-board battery by the charging pile.

### RELATED APPLICATIONS

This application claims priority to Chinese patent application NO. 201711250687.4, filed Dec. 1, 2017 and entitled “Charging Pile”, which is incorporated herein by reference in its entirety.

### TECHNICAL FIELD

This application relates to the field of power battery charging, and in particular, to a charging pile.

### BACKGROUND

With the development of science and technology and new energy, pure electric vehicles have been more and more popularized and applied for their unique advantages. The power battery of the pure electric vehicle has low internal resistance, and the battery temperature increases little under vehicle operating conditions. If the initial temperature of the battery is controlled at a proper range, the final operating temperature of the battery is not too high, thereby ensuring the durability and safety of the battery.

With increasing requirements of users on charging time, fast charging and super-fast charging functions have become future development trends. High temperature and low temperature may affect the safety and durability of the battery. The high temperature and low temperature problems of the battery system are more prominent under fast charging, making thermal management an inevitable choice. However, in the design scheme of related technologies, the charging pile usually requires a long charging time, and is difficult to meet the thermal management requirements of the power battery with large-rate charging and fast heating at low temperature.

### SUMMARY

Based on this, it is necessary to provide a charging pile capable of fast charging to resolve the problems that the traditional charging pile requires a long charging time and can hardly meet the demands of large-rate charging and fast heating at low temperature.

In one embodiment, a charging pile includes a coolant heat exchange device. The coolant heat exchange device includes:

a heat exchange tube; and

a coolant output tube and a coolant input tube that are connected to the heat exchange tube. The coolant output tube and the coolant input tube are respectively used to communicate with a cooling tube of an on-board battery, so that the heat exchange tube and the cooling tube of the on-board battery form a loop.

In one embodiment, a charging pile includes a coolant heat exchange device, where the coolant heat exchange device includes:

a heat exchange tube;

a coolant output tube and a coolant input tube that are connected to the heat exchange tube, where the coolant output tube and the coolant input tube are respectively used to communicate with a cooling tube of an on-board battery, so that the heat exchange tube and the cooling tube of the on-board battery form a loop;

a charging device, where the charging device is electrically connected to a signal control unit; and

a charging interface, where the charging interface is electrically connected to both the charging device and the on-board battery and is used to charge the on-board battery.

The charging pile provided in this application includes a coolant heat exchange device. The coolant heat exchange device includes a heat exchange tube, a coolant output tube and a coolant input tube that are connected to the heat exchange tube. The coolant output tube and the coolant input tube are respectively used to communicate with a cooling tube of an on-board battery, so that the heat exchange tube and the cooling tube of the on-board battery form a loop. The coolant heat exchange device can be communicated with the cooling tube of the on-board battery through the coolant output tube and the coolant input tube, to form a loop of the coolant tube. Through the loop of the coolant tube, the coolant heat exchange device of the charging pile can realize heating and cooling of a battery pack of a pure electric vehicle, to ensure that the on-board battery can be charged within an optimal temperature range. When charging a pure electric vehicle, because the charging pile is equipped with the coolant heat exchange device, the charging pile can ensure that the power battery is charged at a most suitable temperature according to the ambient temperature, the current temperature of the power battery, and the different charging requirements of the power battery. Therefore, the charging pile can meet the thermal management requirements of the on-board battery, and ensure the initial discharge temperature of the on-board battery within a suitable range, thereby accelerating the charging speed of the charging pile and reducing the time for charging the on-board battery by the charging pile.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a schematic diagram of an operating state of a charging pile according to this application;

FIG. 2 is a structural schematic diagram of a first interface of a charging pile according to this application;

FIG. 3 is a structural schematic diagram of a second interface of a charging pile according to this application; and

FIG. 4 is a schematic diagram of an internal structure of an operating state of a charging pile according to this application.

### DESCRIPTION OF REFERENCE NUMERALS

Charging pile 100, coolant heat exchange device 110, signal control device 120, charging device 130, signal control unit 102, coolant pump 105, heat exchanger 106, heat dissipation fan 107, heat dissipation tank 108, auxiliary liquid tank 109, signal line 121, heat exchange tube 111, first interface 210, second interface 220, third interface 230, charging interface 240, coolant output tube 212, coolant input tube 222, first signal receiving end 214, second signal receiving end 224, first signal line switch 401, and second signal line switch 402.

### DETAILED DESCRIPTION

To make the objectives, technical solutions, and advantages of the present invention clearer, the following describes the present invention in more detail with reference to the embodiments. It should be understood that the embodiments described herein are merely used to explain the present application, rather than to limit the present application.

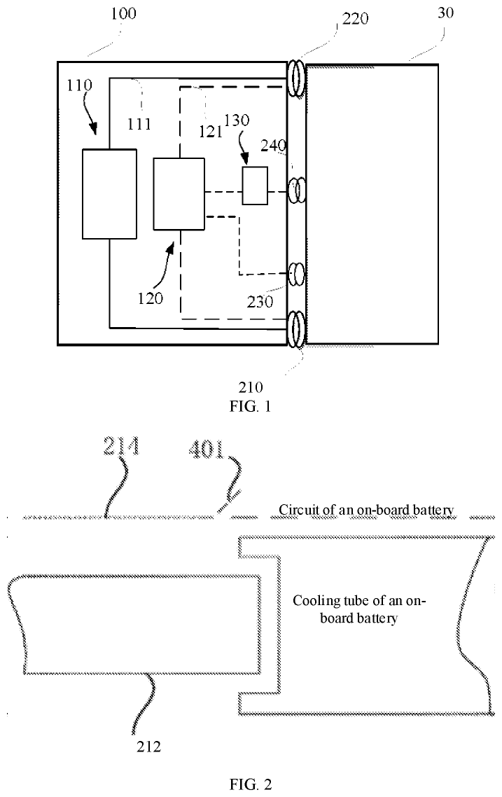

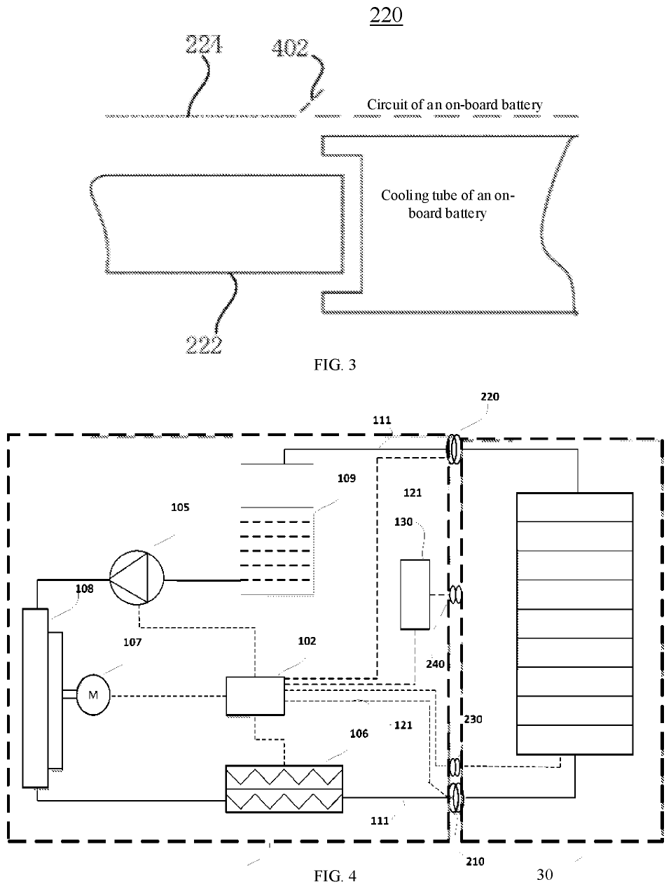

Referring to FIG. 1 to FIG. 3, this application provides a charging pile 100, which includes a coolant heat exchange device 110. The coolant heat exchange device 110 includes a heat exchange tube 111, a coolant output tube 212 and a coolant input tube 222 that are connected to the heat exchange tube 111. When the charging pile 100 is operating, the coolant output tube 212 and the coolant input tube 222 are respectively used to communicate with a cooling tube of an on-board battery 30, so that the heat exchange tube 111 and the cooling tube of the on-board battery 30 form a loop.

When the charging pile 100 is operating, the coolant output tube 212 is configured to communicate with the cooling tube of the on-board battery 30, and to input the coolant to the cooling tube of the on-board battery 30. The coolant input tube 222 is configured to communicate with the cooling tube of the on-board battery 30, and to input the coolant in the cooling tube of the on-board battery 30 to the heat exchange tube 111. The coolant heat exchange device 110 can be communicated with the cooling tube of the on-board battery 30 through the coolant output tube 212 and the coolant input tube 222, to form a loop of the coolant tube. Through the loop of the coolant tube, the coolant heat exchange device 110 of the charging pile 100 can realize heating and heat dissipation of the battery pack of a pure electric vehicle, to ensure that the on-board battery 30 can be charged within an optimal temperature range.

When charging a pure electric vehicle, because the charging pile 100 is equipped with the coolant heat exchange device 110, the charging pile 100 can ensure that the power battery is charged at a most suitable temperature according to the ambient temperature, the current temperature of the power battery, and the different charging requirements of the power battery. Therefore, the charging pile 100 can meet the thermal management requirements of the on-board battery 30, and ensure the initial discharge temperature of the on-board battery 30 within a suitable range, thereby accelerating the charging speed of the charging pile 100 and reducing the time for charging the on-board battery by the charging pile 100.

In one embodiment, the charging pile 100 further includes a signal control device 120. The signal control device 120 includes a signal line 121, a first signal receiving end 214 electrically connected to the signal line 121, and a second signal receiving end 224 electrically connected to the signal line 121. When the charging pile 100 is operating, the first signal receiving end 214 is electrically connected to a loop of the on-board battery 30. The second signal receiving end 224 is electrically connected to the loop of the on-board battery 30. When the charging pile 100 is operating, the coolant output tube 212 and the coolant input tube 222 are respectively used to communicate with the cooling tube of the on-board battery 30 to form a loop, and the first signal receiving end 214 and the second signal receiving end 224 are respectively connected to the loop of the on-board battery 30 through a wire to implement signal transmission. At this time, the signal control device 120 receives a signal that the cooling tube is communicated, and then controls the charging and discharging of the charging pile 100 to meet the thermal management requirements of the power battery.

In one embodiment, a first signal line switch 401 is provided at an electrical connection position between the first signal receiving end 214 and the loop of the on-board battery 30. A second signal line switch 402 is provided at an electrical connection position between the second signal receiving end 224 and the loop of the on-board battery 30. The charging pile 100 further includes a first interface 210 and a second interface 220. The first interface 210 includes the coolant output tube 212, the first signal line switch 401, and the first signal receiving end 214. The second interface 220 includes the coolant input tube 222, the second signal line switch 402, and the second signal receiving end 224. When the charging pile 100 is operating, the coolant output tube 212 is communicated with the cooling tube of the on-board battery 30, and the first signal line switch 401 is closed. When the coolant input tube 222 is communicated with the cooling tube of the on-board battery 30, and the second signal line switch 402 is closed. Therefore, by detecting whether the first signal line switch 401 and the second signal line switch 402 are closed, it can be determined whether the heat exchange tube 111 and the cooling tube of the on-board battery 30 form a loop.

Referring to FIG. 4, in one embodiment, the signal control device 120 further includes a signal control unit 102. The signal control unit 102 is electrically connected to the signal line 121 to detect whether the charging pile 100 is communicated with the cooling tube of the on-board battery 30. The signal control unit 102 is electrically connected to the signal line 121 through a wire, and the signal line 121 is electrically connected to the first signal receiving end 214 and the second signal receiving end 224 through a wire, respectively. Therefore, when the first signal line switch 401 and the second signal line switch 402 are closed, the signal control unit 102 can receive the signal of the loop formed by the heat exchange tube 111 and the cooling tube of the on-board battery 30 through a wire.

In one embodiment, the coolant heat exchange device 110 further includes an auxiliary liquid tank 109, a coolant pump 105, a heat dissipation tank 108, and a heat exchanger 106. One port of the auxiliary liquid tank 109 is communicated with the coolant input tube 222 through a tube to communicate with the cooling tube of the on-board battery 30. One port of the coolant pump 105 is communicated with the other port of the auxiliary liquid tank 109 through a tube. One port of the heat dissipation tank 108 is communicated with the other port of the coolant pump 105 through a tube. One port of the heat exchanger 106 is communicated with the other port of the heat dissipation tank 108 through a tube; and the other port of the heat exchanger 106 is communicated with the coolant output tube 212 through a tube and is used to communicate with the cooling tube of the on-board battery 30. When the charging pile 100 is operating, the charging pile 100 has the function of a battery pack thermal management system in a vehicle, and moves the coolant pump 105, the heat dissipation tank 108, the auxiliary liquid tank 109, and the heat exchanger 106 that are vehicle-mounted outside the vehicle, thus achieving universal cooling and high-power cooling of different types of vehicles and batteries. The charging pile 100 reduces the on-board weight of the thermal management device, reduces the complexity of the on-board thermal management device, reduces the cost of the power battery box, and improves the energy density of the battery pack, which is conducive to the improvement of the driving mileage of the electric vehicle.

When the charging pile 100 is operating, a heat exchange loop can be formed between the auxiliary liquid tank 109, the coolant pump 105, the heat dissipation tank 108, the heat exchanger 106, and the cooling tube of the on-board battery 30. Both ends of the auxiliary liquid tank 109 are communicated with the coolant pump 105 and the coolant input tube 222 through tubes, respectively, and are mainly configured to realize the functions of expansion storage and liquid-shortage compensation. When temperature of liquid medium in the conduit increases, the volume expansion of the liquid will occur, so that the auxiliary liquid tank 109 will absorb the volume of the liquid expansion, and at this time, some liquid medium will flow into the auxiliary liquid tank 109. When the temperature of the liquid medium in the conduit decreases, the volume shrinks or the amount of liquid in the liquid loop decreases, and some liquid will flow from the auxiliary liquid tank 109 into the loop, so that the amount of liquid in the liquid loop can be compensated. One end of the heat dissipation tank 108 is connected to the coolant pump 105 through a conduit, and the other end of the heat dissipation tank 108 is connected to the heat exchanger 106 through a conduit. When the on-board battery 30 reaches an optimal temperature, the signal control device 120 controls the coolant pump 105 to stop operating, thereby controlling the coolant heat exchange device 110 to stop operating, and at this time, the on-board battery 30 starts to charge.

In one embodiment, the coolant heat exchange device 110 further includes a heat dissipation fan 107. The heat dissipation fan 107 is fixedly disposed on the heat dissipation tank 108. The heat dissipation fan 107 is electrically connected to the signal control unit 102 and is configured to assist the heat dissipation tank 108 in dissipating heat. When the charging pile 100 is operating and the battery temperature is high, the heat dissipation fan 107 can assist the heat dissipation tank 108 in cooling the liquid medium, so as to better control the operating temperature of the on-board battery 30. The heat dissipation tank operates under the control of the signal control unit 102, and is electrically connected to the heat dissipation fan 107 through a wire. If the temperature of the on-board battery 30 is too high and reaches a set temperature at which the heat dissipation fan 107 is started, the signal control unit 102 will control the heat dissipation fan 107 to start, thereby assisting the heat dissipation tank 108 in performing cooling on the liquid medium.

In one embodiment, the signal control unit 102 is electrically connected to the coolant pump 105. When the on-board battery 30 reaches an optimal temperature, the signal control unit 102 controls the coolant pump 105 to stop operating, thereby controlling the coolant heat exchange device 110 to stop operating, and at this time, the on-board battery 30 starts to charge.

In one embodiment, the signal control unit 102 is electrically connected to the heat exchanger 106. When the charging pile 100 is operating and the temperature of the on-board battery 30 is not at the optimal temperature in the charging state, the signal control unit 102 may control the heat exchanger 106 to wake up functions of heating or cooling to ensure that the on-board battery 30 is in an optimal operating temperature range and is maintained within a reasonable operating temperature range.

In one embodiment, the charging pile 100 further includes a third interface 230. The third interface 230 is electrically connected to the signal control unit 102, and is electrically connected to the on-board battery 30 to detect the temperature of the on-board battery 30. When the charging pile 100 is operating, the signal control unit 102 detects the temperature of the liquid medium in the cooling conduit of the on-board battery 30, and the signal control unit 102 can control the operating states of the coolant heat exchange device 110 and the signal control device 120, so that the on-board battery 30 is always at an optimal temperature in a charging state.

In one embodiment, the heat exchange tube 111 is used to be a liquid cooling tube. There is water in the liquid cooling tube. Because the specific heat capacity of water is very large, it can absorb a large amount of heat without causing a significant change in temperature, and the temperature can be well controlled. Generally, the immersion liquid cooling method requires electrically insulated flame-retardant liquid, which is expensive, but the liquid cooling tube has a relatively low cost, thus reducing the cost.

In one embodiment, the charging pile 100 further includes a charging device 130 and a charging interface 240. The charging interface 240 is electrically connected to both the charging device 130, and is connected to the on-board battery 30 through a cable, so as to charge the on-board battery 30. When the charging pile 100 is operating and the temperature of the on-board battery 30 is at an optimal temperature in the charging state, the charging device 130 starts to perform fast charging on the on-board battery 30.

The first interface 210 includes the coolant output tube 212, the first signal line switch 401, and the first signal receiving end 214. The second interface 220 includes the coolant input tube 222, the second signal line switch 402, and the second signal receiving end 224. The charging pile 100 provides a cooling system interface and an information interaction interface that are connected to the on-board battery 30. When the charging pile 100 is operating, through coordination of various components of the charging pile 100, heating or cooling of the on-board battery 30 can be achieved, so as to ensure that the on-board battery 30 can always operate at an appropriate temperature range under different operating conditions.

When the charging pile 100 charges the on-board battery 30, the on-board battery 30 is first connected to the charging pile 100 through a cable to form a charging loop. At this time, the charging interface 240 is electrically connected to the on-board battery 30 through a cable. The first interface 210 and the second interface 220 are respectively connected, and the on-board battery 30 and the charging pile 100 form a cooling loop. The coolant in the auxiliary liquid tank 109 is pumped into the cooling loop through the coolant pump 105, so that the liquid cooling tube in the on-board battery 30 is filled with coolants. Then, the signal control unit 102 can obtain the battery temperature of the on-board battery 30 through a sensor, and pre-heat treatment after cooling before charging the on-board battery 30 can be implemented by controlling the heat dissipation fan 107 or the heat exchanger 106, thereby ensuring that the battery is at the optimal charging initial temperature. Subsequently, the signal control unit 102 adjusts the output power of the heat dissipation fan 107, the heat exchanger 106, and the coolant pump 105 according to the battery charging rate requirement, the battery type and parameters, and the real-time temperature in the on-board battery 30, to ensure that the on-board battery 30 supplies power within a suitable temperature range. When the temperature of the on-board battery 30 is within the optimal temperature range in the charging state, the charging device 130 starts to perform fast charging on the on-board battery 30. In addition, the battery is at the optimal operating initial temperature after charging is completed.

After the charging process of the on-board battery 30 is completed, the signal control unit 102 controls the coolant pump 105 to pump the coolant in the on-board battery 30 back to the auxiliary liquid tank 109. Finally, when the first interface 210 is disconnected from the second interface 220, the on-board battery 30 can be maintained within a reasonable temperature range by natural cooling under the operating state of the electric vehicle.

In one embodiment, when the on-board battery 30 is in a fast-charging state, the on-board battery 30 is charged at a high charging rate, where the charging rate is a value in the range of 1C-10C, and the power battery generates a lot of heat during the charging process. The on-board battery 30 is first connected to the charging pile 100 through a cable to form a charging loop. At this time, the charging interface 240 is electrically connected to the on-board battery 30 through a cable. The first interface 210 and the second interface 220 are respectively connected, and the on-board battery 30 and the charging pile 100 form a cooling loop. When the signal control unit 102 detects a signal that the cooling loop is turned on, the signal control unit 102 controls the coolant pump 105 to inject the liquid medium in the auxiliary liquid tank 109 into the cooling loop. The signal control unit 102 may estimate the heat output of the on-board battery 30 according to a battery type, a battery parameter, and a preset charging rate in the on-board battery 30, and can take it as a feedforward control parameter. The signal control unit 102 obtains a real-time temperature of the on-board battery 30 at this time according to a temperature signal in the on-board battery 30 and takes it as a feedback control parameter. Therefore, the signal control unit 102 can control the operating power of the heat dissipation tank 108, the coolant pump 105, and the heat exchanger 106 according to the feedback control parameters to ensure that the on-board battery 30 is always operating within the optimum charging temperature range in the fast charging process.

In one embodiment, when the on-board battery 30 is in a low temperature environment, the on-board battery 30 is standing in the low temperature environment before charging. The initial charging temperature of the on-board battery 30 is −40° C.-10° C. At this time, charging the on-board battery 30 may adversely affect the safety and life of the on-board battery 30. Therefore, under this environment, the on-board battery 30 is first connected to the charging pile 100 through a cable to form a charging loop. At this time, the charging interface 240 is electrically connected to the on-board battery 30 through a cable. The first interface 210 and the second interface 220 are respectively connected, and the on-board battery 30 and the charging pile 100 form a cooling loop. When the signal control unit 102 detects a signal that the cooling loop is turned on, the signal control unit 102 controls the coolant pump 105 to inject the liquid medium in the auxiliary liquid tank 109 into the cooling loop. At this time, the low-temperature signal of the on-board battery 30 is detected by the signal control unit 102, the signal control unit 102 sends a charging start time delay signal, and the charging process of the charging pile is temporarily suspended. The signal control unit 102 performs rapid heating on the on-board battery 30 by controlling the heat exchanger 106 and the coolant pump 105. When the temperature in the on-board battery 30 reaches a suitable charging initial temperature of 20° C.-30° C., the heating process is stopped. The signal control unit 102 cancels the sending of the charging start time delay signal. When the temperature of the on-board battery 30 is within the optimal temperature range in the charging state, the charging device 130 starts to perform fast charging on the on-board battery 30. The operating mode of the charging pile 100 is the same as that when the on-board battery 30 is in a fast charging state.

In one embodiment, before the charging pile 100 is disconnected from the on-board battery 30, the signal control unit 102 controls the operating power of the heat dissipation fan 107, the coolant pump 105, and the heat exchanger 106. According to the battery temperature of the on-board battery 30, the temperature of the power battery is adjusted to the most suitable initial use temperature, which is typically 25° C. Under the starting temperature, the power battery uses natural convection heat transfer to achieve that the power battery is always within a suitable operating temperature range during use, which is typically 10° C.-50° C. At this time, after the charging pile 100 is disconnected from the on-board battery 30, the on-board battery 30 may be in a typical driving operating state of an electric vehicle.

In one embodiment, when the electric vehicle is turned off and charged during driving, the first interface 210, the second interface 220, the third interface 230, and the charging interface 240 are first connected. The signal control unit 102 detects a battery temperature of the on-board battery 30 through the third interface 230, and the signal control unit 102 detects a signal when the first interface 210 and the second interface 220 are connected. At this time, the signal control unit 102 controls the coolant pump 105 to inject the liquid medium in the auxiliary liquid tank 109 into the cooling loop. The signal control unit 102 performs rapid cooling on the on-board battery 30 by controlling the heat exchanger 106 and the coolant pump 105. The signal control unit 102 obtains a real-time temperature of the on-board battery 30 at this time according to a temperature signal in the on-board battery 30 and takes it as a feedback control parameter. When the temperature in the on-board battery 30 reaches a suitable charging initial temperature of 20° C.-30° C., the signal control unit 102 detects the temperature in the on-board battery 30, and the cooling process is stopped. The signal control unit 102 receives charging information, and at this time, the charging device 130 charges the on-board battery 30 through the charging interface 240. Because the charging pile 100 charges the on-board battery 30 always in a proper temperature state, the time for charging the on-board battery is reduced, and the problem that the traditional charging pile requires a long charging time is resolved. In addition, it meets the needs of large-rate charging and fast heating at low temperature, and provides a charging pile capable of fast charging.

The technical features of the above embodiments may be arbitrarily combined. For brevity of description, all possible combinations of the technical features in the above embodiments are not described. However, as long as there is no contradiction between the combinations of these technical features, all these combinations should be considered as the scope of this specification.

The above embodiments are merely illustrative of several implementation manners of the present invention, and the description thereof is more specific and detailed, but is not to be construed as a limitation to the patentable scope of the present invention. It should be pointed out that several variations and improvements can be made by those of ordinary skill in the art without departing from the conception of the present invention, but such variations and improvements should fall within the protection scope of the present invention. Therefore, the protection scope of the patent of the present invention should be subject to the appended claims.

1. A charging pile, comprising a coolant heat exchange device, wherein the coolant heat exchange device comprises:
a heat exchange tube; and
a coolant output tube and a coolant input tube that are connected to the heat exchange tube, wherein the coolant output tube and the coolant input tube are respectively used to communicate with a cooling tube of an on-board battery, so that the heat exchange tube and the cooling tube of the on-board battery form a loop.

2. The charging pile according to claim 1, wherein the charging pile 100 further comprises a signal control device electrically connected to the loop of the on-board battery.

3. The charging pile according to claim 2, wherein the signal control device comprises:
a signal line;
a first signal receiving end electrically connected to the signal line, wherein the first signal receiving end is electrically connected to the loop of the on-board battery; and
a second signal receiving end electrically connected to the signal line, wherein the second signal receiving end is electrically connected to the loop of the on-board battery.

4. The charging pile according to claim 3, wherein a first signal line switch is provided at an electrical connection position between the first signal receiving end and the loop of the on-board battery, and a second signal line switch is provided at an electrical connection position between the second signal receiving end and the loop of the on-board battery.

5. The charging pile according to claim 3, wherein the signal control device further comprises a signal control unit, wherein the signal control unit is electrically connected to the signal line, and is used to detect whether the charging pile is communicated with the cooling tube of the on-board battery.

6. The charging pile according to claim 1, wherein the coolant heat exchange device further comprises an auxiliary liquid tank, wherein one port of the auxiliary liquid tank is communicated with the coolant input tube through a tube, and the auxiliary liquid tank is used to communicate with the cooling tube of the on-board battery.

7. The charging pile according to claim 6, wherein the coolant heat exchange device further comprises a coolant pump, and one port of the coolant pump is communicated with the other port of the auxiliary liquid tank through a tube.

8. The charging pile according to claim 7, wherein the coolant heat exchange device further comprises a heat dissipation tank, and one port of the heat dissipation tank is communicated with the other port of the coolant pump through a tube.

9. The charging pile according to claim 8, wherein:
the coolant heat exchange device further comprises a heat exchanger, and one port of the heat exchanger is communicated with the other port of the heat dissipation tank through a tube; and
the other port of the heat exchanger is communicated with the coolant output tube through a tube and is used to communicate with the cooling tube of the on-board battery.

10. The charging pile according to claim 8, wherein the coolant heat exchange device further comprises a heat dissipation fan, wherein the heat dissipation fan is fixedly disposed on the heat dissipation tank, and the heat dissipation fan is electrically connected to the signal control unit and is used to assist the heat dissipation tank in dissipating heat.

11. The charging pile according to claim 5, wherein the signal control unit is electrically connected to the coolant pump.

12. The charging pile according to claim 5, wherein the signal control unit is electrically connected to the heat exchanger.

13. The charging pile according to claim 1, wherein the charging pile further comprises a third interface, wherein the third interface is electrically connected to both the signal control unit and the on-board battery, and is used to detect the temperature of the on-board battery.

14. The charging pile according to claim 1, wherein the heat exchange tube is a liquid cooling tube.

15. A charging pile, comprising a coolant heat exchange device, wherein the coolant heat exchange device comprises:
a heat exchange tube;
a coolant output tube and a coolant input tube that are connected to the heat exchange tube, wherein the coolant output tube and the coolant input tube are respectively used to communicate with a cooling tube of an on-board battery, so that the heat exchange tube and the cooling tube of the on-board battery form a loop;
a charging device, wherein the charging device is electrically connected to a signal control unit; and
a charging interface, wherein the charging interface is electrically connected to both the charging device and the on-board battery, and is used to charge the on-board battery.

16. The charging pile according to claim 15, wherein the charging pile further comprises a signal control device, wherein the signal control device comprises:
a signal line;
a first signal receiving end electrically connected to the signal line, wherein the first signal receiving end is electrically connected to a loop of the on-board battery; and
a second signal receiving end electrically connected to the signal line, wherein the second signal receiving end is electrically connected to the loop of the on-board battery.

17. The charging pile according to claim 16, wherein a first signal line switch is provided at an electrical connection position between the first signal receiving end and the loop of the on-board battery, and a second signal line switch is provided at an electrical connection position between the second signal receiving end and the loop of the on-board battery.

18. The charging pile according to claim 16, wherein the signal control device further comprises a signal control unit, wherein the signal control unit is electrically connected to the signal line, and is used to detect whether the charging pile is communicated with the cooling tube of the on-board battery.

19. The charging pile according to claim 15, wherein the coolant heat exchange device further comprises:
an auxiliary liquid tank, wherein one port of the auxiliary liquid tank is communicated with the coolant input tube through a tube, and the auxiliary liquid tank is used to communicate with the cooling tube of the on-board battery;
a coolant pump, wherein the coolant pump is electrically connected to the signal control unit, and one port of the coolant pump is communicated with the other port of the auxiliary liquid tank through a tube;
a heat dissipation tank, wherein one port of the heat dissipation tank is communicated with the other port of the coolant pump through a tube; and
a heat exchanger, wherein the heat exchanger is electrically connected to the signal control unit, one port of the heat exchanger is communicated with the other port of the heat dissipation tank through a tube, and the other port of the heat exchanger is communicated with the coolant output tube through a tube and is used to communicate with the cooling tube of the on-board battery.

20. The charging pile according to claim 19, wherein the coolant heat exchange device further comprises a heat dissipation fan, wherein the heat dissipation fan is fixedly disposed on the heat dissipation tank, and the heat dissipation fan is electrically connected to the signal control unit and is used to assist the heat dissipation tank in dissipating heat.
